SEQUENCE LISTING (5 sequences)

SEQ ID NO: 1 - DNA, 21 bp, Artificial
  DNA sequence capable of forming the G-quadruplex
gggttagggttagggttaggg

SEQ ID NO: 2 - DNA, 6 bp, Artificial
  DNA sequence capable of forming the G-quadruplex
tggggt

SEQ ID NO: 3 - DNA, 9 bp, Artificial
  DNA sequence capable of forming the G-quadruplex
gggtttggg

SEQ ID NO: 4 - DNA, 12 bp, Artificial
  single-stranded DNA capable of forming a ssDNA
tttttttttttt

SEQ ID NO: 5 - DNA, 12 bp, Artificial
  double-stranded DNA capable of forming a dsDNA
agaagagaaaga

(19) United States
(12) Patent Application Publication
(10) Pub. No.: US 2014/0048753 A1
(43) Pub. Date: Feb. 20, 2014

(54) METHOD FOR DISSOLVING A PHTHALOCYANINE COMPOUND IN WATER WITH USE OF G-QUADRUPLEX

(71) Applicant: PANASONIC CORPORATION, OSAKA (JP)

(72) Inventors: Hidenobu YAKU, Hyogo (JP); Daisuke MIYOSHI, Kyoto (JP); Takashi MURASHIMA, Hyogo (JP)

(73) Assignee: PANASONIC CORPORATION, OSAKA (JP)

(21) Appl. No.: 14/015,566

(22) Filed: Aug. 30, 2013

Related U.S. Application Data
(63) Continuation of application No. PCT/JP2012/003486, filed on May 29, 2012.

(30) Foreign Application Priority Data
Aug. 4, 2011 (JP) 2011-170678

(51) Int. Cl. C09B 67/44; G02B 1/04

(52) U.S. Cl. CPC C09B 67/0083; G02B 1/04
USPC 252/587; 106/31.36

(57) ABSTRACT

The present invention provides a method for obtaining an aqueous solution where divalent metal cations, a phthalocyanine compound modified with an anionic functional group, and G-quadruplex are dissolved, the method comprising step of:
mixing the divalent metal cations, the phthalocyanine compound modified with the anionic functional group, and the G-quadruplex into water so as to dissolve the phthalocyanine compound in the water.

### RELATED APPLICATIONS

This application is a continuation of International Application No. PCT/JP2012/003486, filed on May 29, 2012, which in turn claims the benefit of Japanese Application No. 2011-170678, filed on Aug. 4, 2011, the disclosures of which Applications are incorporated by reference herein.

### SEQUENCE LISTING

The instant application contains a Sequence Listing which has been submitted in ASCII format via EFS-Web and is hereby incorporated by reference in its entirety. Said ASCII copy, created on Aug. 30, 2013, is named 44389859_{—}1.txt and is 1,346 bytes in size.

### TECHNICAL FIELD

The present invention relates to a method for dissolving a phthalocyanine compound in water with use of G-quadruplex.

### BACKGROUND

Since a phthalocyanine compound has a large pi planar, the phthalocyanine compound is poorly water-soluble.

Patent Literatures 1-3 disclose a method for dissolving a phthalocyanine compound in water. More particularly, the phthalocyanine compound is modified with a sulfo group, a metal salt of the sulfo group, a carboxyl group, or a metal salt of the carboxyl group. The modification with this functional group allows the phthalocyanine compound to be dissolved in water.

### CITATION LIST

### Patent Literature

[Patent Literature 1]

Japanese laid-open patent application publication No. Sho 60-092369A

[Patent Literature 2]

Japanese laid-open patent application publication No. Hei 7-070129A

[Patent Literature 3]

Japanese laid-open patent application publication No. 2005-220060A

### SUMMARY OF INVENTION

### Technical Problem

However, even when the phthalocyanine compound modified with these functional groups is used, the phthalocyanine compound is precipitated in the aqueous solution containing divalent metal cations.

The purpose of the present invention is to provide a method for dissolving a phthalocyanine compound in an aqueous solution containing divalent metal cations.

### Solution to Problem

The present invention relates to a method for obtaining an aqueous solution where divalent metal cations, a phthalocyanine compound modified with an anionic functional group, and G-quadruplex are dissolved, the method comprising step of:

(a) mixing the divalent metal cations, the phthalocyanine compound modified with the anionic functional group, and the G-quadruplex into water so as to dissolve the phthalocyanine compound in the water.

In the step (a), the divalent metal cations, the phthalocyanine compound modified with an anionic functional group, and the G-quadruplex are preferably mixed at the same time.

The present invention also relates to a method for obtaining an aqueous solution where divalent metal cations, a phthalocyanine compound modified with an anionic functional group, and G-quadruplex are dissolved, the method comprising step of:

(b) mixing the G-quadruplex into an aqueous solution containing the divalent metal cations and the phthalocyanine compound modified with the anionic functional group so as to dissolve the phthalocyanine compound in the aqueous solution.

The anionic functional group is preferably at least one selected from the group consisting of a carboxyl group, a metal salt of the carboxyl group, a sulfo group, and a metal salt of the sulfo group.

The present invention also relates to a method for obtaining an aqueous solution where divalent metal cations, a phthalocyanine compound modified with an anionic functional group, and G-quadruplex are dissolved, the method comprising step of:

(c) mixing the divalent metal cations into an aqueous solution containing the G-quadruplex and the phthalocyanine compound modified with the anionic functional group so as to dissolve the phthalocyanine compound in the aqueous solution.

The present invention also relates to a method for obtaining an aqueous solution where divalent metal cations, a phthalocyanine compound modified with an anionic functional group, and G-quadruplex are dissolved, the method comprising step of:

(d) mixing the phthalocyanine compound modified with the anionic functional group into an aqueous solution containing the G-quadruplex and the divalent metal cations so as to dissolve the phthalocyanine compound in the aqueous solution.

The anionic functional group is preferably at least one selected from the group consisting of a carboxyl group, a metal salt of the carboxyl group, a sulfo group, and a metal salt of the sulfo group.

The phthalocyanine compound preferably contains copper, zinc, cobalt, or nickel as a coordination metal.

The phthalocyanine compound preferably contains no coordination metal.

The divalent metal cation is preferably at least one selected from the group consisting of magnesium ion, nickel ion, cobalt ion (II), copper ion, zinc ion, and iron ion (II).

The G-quadruplex is preferably formed of four DNAs each consisting of 5′−GGGTTAGGGTTAGGGTTAGGG-3′ (SEQ ID:01), 5′-TGGGGT-3′ (SEQ ID:02), or 5′−GGGTTTGGG-3′ (SEQ ID:03).

### Advantageous Effects of Invention

The present invention provides a method for dissolving a phthalocyanine compound in an aqueous solution containing divalent metal cations.

### BRIEF DESCRIPTION OF DRAWINGS

FIG. 1 is a photograph showing the results of the examples 1A-1B and the comparative examples 1A-1C.

FIG. 2 is a photograph showing the results of the example 2 and the comparative example 2.

FIG. 3 shows the results of the absorbance measurements in the example 4 and the comparative example 4.

FIG. 4 shows the results of the absorbance measurements in the example 5 and the comparative example 5.

FIG. 5A shows the result of the absorbance measurement in the example 6.

FIG. 5B shows the measurement result of the chronological change of the absorbance at 650 nanometers according to the example 6.

FIG. 6 shows the measurement result of the chronological change of the absorbance at 650 nanometers according to the example 7.

FIG. 7 shows the measurement result of the chronological change of the absorbance at 650 nanometers according to the example 8.

### DESCRIPTION OF EMBODIMENTS

The embodiment of the invention is described below.

In the present invention, a phthalocyanine compound is dissolved in an aqueous solution containing divalent metal cations with use of G-quadruplex.

The term “G-quadruplex” means a four-stranded DNA formed of four DNA strands each rich in guanine bases.

An example of the DNA sequence capable of forming the G-quadruplex is 5′-GGGTTAGGGTTAGGGTTAGGG-3′ (SEQ ID:01), 5′-TGGGGT-3′ (SEQ ID:02), or 5′−GGGTTTGGG-3′ (SEQ ID:03).

An example of the divalent metal cation is calcium ion, magnesium ion, cobalt ion, lead ion, or divalent copper ion.

The phthalocyanine compound is modified with an anionic functional group. An example of the anionic functional group is a carboxyl group or a sulfo group. A metal salt of the functional group also may be used.

The divalent metal cations, the phthalocyanine compound, and G-quadruplex are mixed to obtain an aqueous solution where the phthalocyanine compound is dissolved.

Four specific mixing embodiments are described below:

(a) The divalent metal cations, the phthalocyanine compound, and G-quadruplex are mixed into water. Preferably, these are mixed at the same time,

(b) G-quadruplex is mixed into an aqueous solution containing the divalent metal cations and the phthalocyanine compound,

(c) The divalent metal cations are mixed into an aqueous solution containing G-quadruplex and the phthalocyanine compound, or

(d) The phthalocyanine compound is mixed into an aqueous solution containing G-quadruplex and the divalent metal cations.

The following examples and the comparative examples describe the present invention in more detail.

All the single-stranded DNAs used in the examples and in the comparative examples were purchased from TSUKUBA OLIGO SERVICE, CO., LTD. The phthalocyanine compounds were purchased from Sigma-Aldrich Co. LLC.

### Example 1A

In the example 1A, the reagents shown in Table 1 were mixed to obtain an aqueous solution.

TABLE 1

50 mM MES—LiOH(pH: 7)
100 mM KCl
10 mM MgCl₂
100 μM Copper(II) phthalocyanine-
3,4′,4″,4″′-tetrasulfonic acid tetrasodium salt
100 μM G-quadruplex1
Water
(Total volume: 100 microliters)

G-quadruplex1 was formed of DNAs each consisting of 5′−GGGTTAGGGTTAGGGTTAGGG-3′ (SEQ ID:01). With a circular dichroism (CD) spectral analysis technique, it was confirmed that the DNAs consisting of SEQ ID:01 formed an intramolecular G-quadruplex structure.

The aqueous solution thus obtained was stored at 80 degrees Celsius for 2 minutes. Then, the aqueous solution was cooled to 20 degrees Celsius at a rate of 2 degrees Celsius/minute. Thereafter, the aqueous solution was left at room temperature for 12 days.

### Example 1B

In the example 1B, the experiment similar to the one in the example 1A was performed, except that 100 μM G-quadruplex2 was used instead of the 100 μM G-quadruplex1.

G-quadruplex2 was formed of DNAs each consisting of 5′-TGGGGT-3′ (SEQ ID:02). With a circular dichroism (CD) spectral analysis technique, it was confirmed that the DNAs consisting of SEQ ID:02 formed an intermolecular G-quadruplex structure.

### Comparative Example 1A

In the comparative example 1A, the experiment similar to the one in the example 1A was performed, except that single-stranded DNAs consisting of 5′-TTTTTTTTTTTT-3′ (SEQ ID:04, hereinafter, referred to as “ssDNA”) was used instead of the 100 μM G-quadruplex1.

### Comparative Example 1B

In the comparative example 1B, the experiment similar to the one in the example 1A was performed, except that double-stranded DNAs consisting of 5′-AGAAGAGAAAGA-3′ (SEQ ID:05) and 3′-TCTTCTCTTTCT-5′ (the antisense sequence of SEQ ID:05) was used instead of the 100 μM G-quadruplex1.

### Comparative example 1C

In the comparative example 1C, the experiment similar to the one in the example 1A was performed, except that the 100 μM G-quadruplex1 was not used.

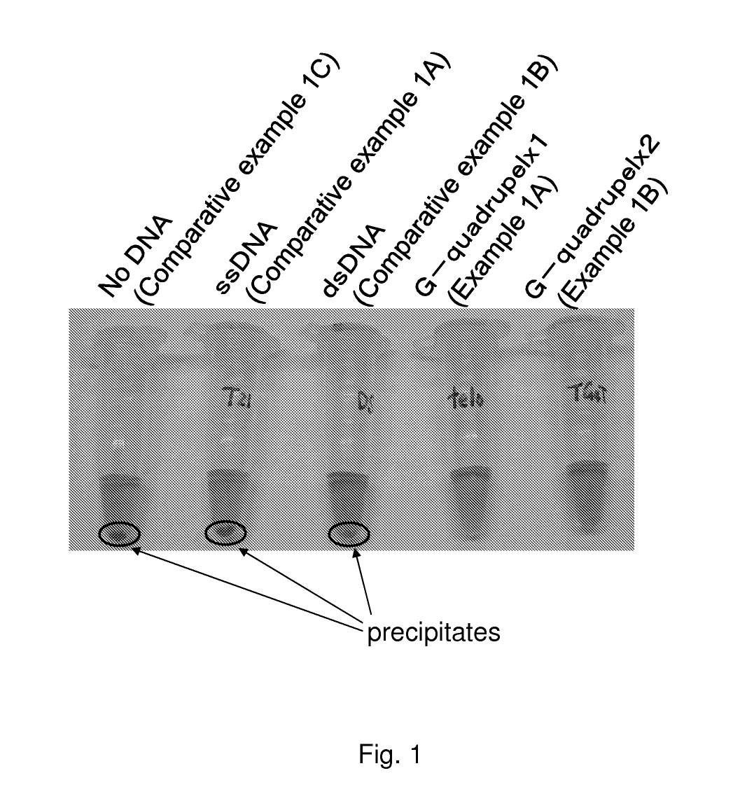

FIG. 1 is a photograph showing the results of the examples 1A-1C and the comparative examples 1A-1C.

As is clear from FIG. 1, no precipitate was observed in the examples 1A-1B. Meanwhile, precipitates were observed in the comparative examples 1A-1C.

### Example 2

In the example 2, the experiment similar to the one in the example 1A was performed, except that 100 μM phthalocyanine tetrasulfonic acid hydrate was used instead of the 100 μM Copper(II) phthalocyanine −3,4′,″, 4′″-tetrasulfonic acid tetrasodium salt.

### Comparative Example 2

In the comparative example 2, the experiment similar to the one in the example 2 was performed except that the 100 μM G-quadruplex1 was not used.

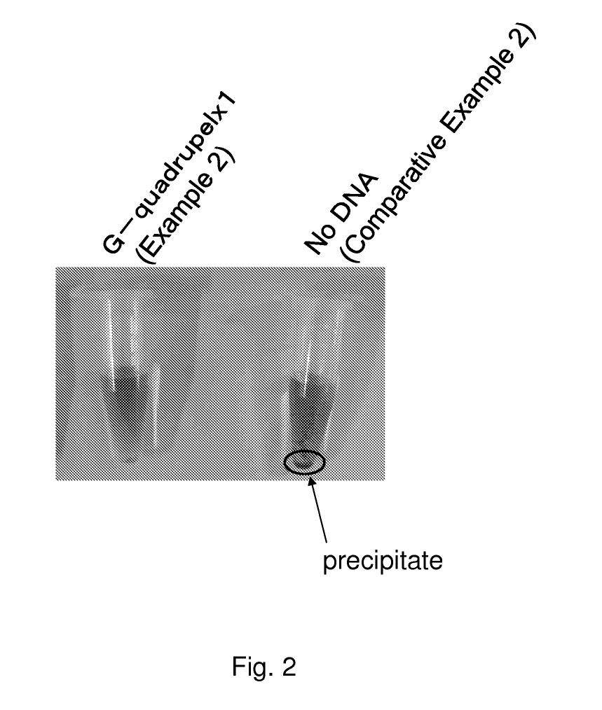

FIG. 2 is a photograph showing the results of the example 2 and the comparative example 2.

As is clear from FIG. 2, no precipitate was observed in the example 2. Meanwhile, a precipitate was observed in the comparative example 2.

### Example 3

In the example 3, the reagents shown in Table 2 were mixed to obtain an aqueous solution.

50 mM MES—LiOH(pH: 7)
100 mM KCl
10 mM MgCl₂
100 μM Nickel(II) phthalocyanine-tetrasulfonic acid
tetrasodium salt
100 μM G-quadruplex1
Water
(Total volume: 100 microliters)

The aqueous solution thus obtained was stored at 80 degrees Celsius for 2 minutes. Then, the aqueous solution was cooled to 20 degrees Celsius at a rate of 2 degrees Celsius/minute. Thereafter, the aqueous solution was left at room temperature for three hours.

### Comparative Example 3

In the comparative example 3, the experiment similar to the one in the example 3 was performed, except that the 100 μM G-quadruplex1 was not used.

No precipitate was observed in the example 3. Meanwhile, a precipitate was observed in the comparative example 3.

### Example 4

In the example 4, the reagents shown in Table 3 were mixed to obtain an aqueous solution.

TABLE 3
50 mM MES—LiOH(pH: 7)
100 mM KCl
10 mM CoCl₂
100 μM Copper(II) phthalocyanine-3,4′,4″,4′″-tetrasulfonic
acid tetrasodium salt
100 μM G-quadruplex1
Water
(Total volume: 100 microliters)

The aqueous solution thus obtained was stored at 80 degrees Celsius for 2 minutes. Then, the aqueous solution was cooled to 20 degrees Celsius at a rate of 2 degrees Celsius/minute. Thereafter, the aqueous solution was left at room temperature for three hours.

### Comparative Example 4

In the comparative example 4, the experiment similar to the one in the example 4 was performed, except that the 100 μM G-quadruplex1 was not used.

The absorbance of the aqueous solutions obtained in the example 4 and the comparative Example 4 was measured with use of an ultraviolet-visible spectrophotometer (Shimadzu Co. Ltd., trade name: UV-1800).

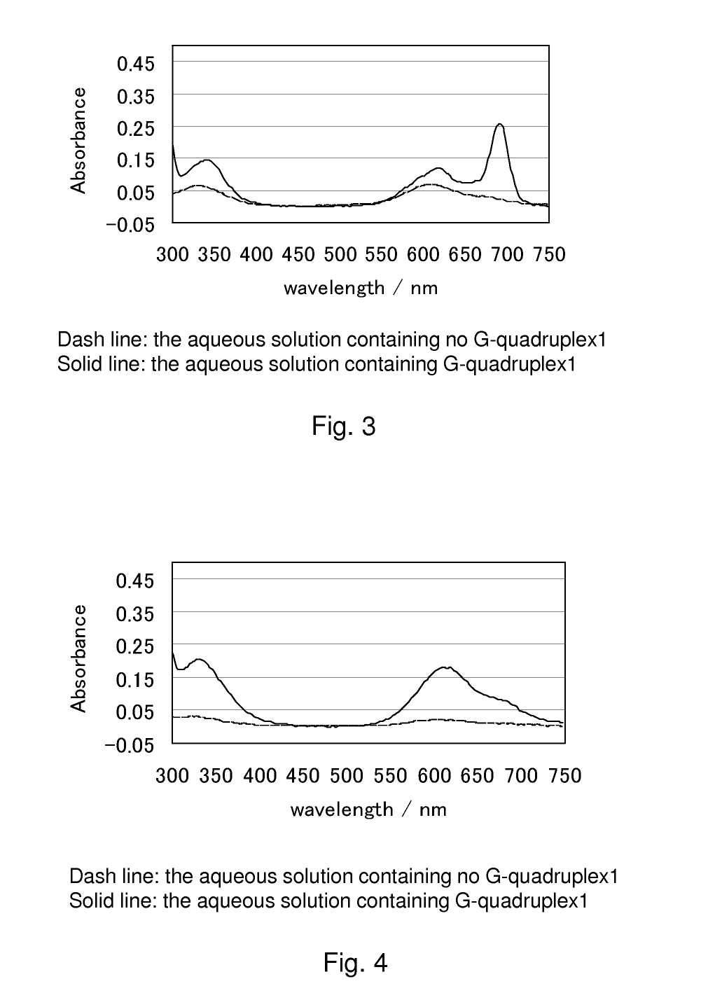

FIG. 3 shows these results of the absorbance.

As shown in FIG. 3, in the Example 4, a first absorbance peak and a second absorbance peak were observed at a wavelength of 300 nanometers-400 nanometers and at a wavelength of 600 nanometers-700 nanometers, respectively.

The first absorption peak is an absorption peak specific to the phthalocyanine compound, and called “Soret band”. The second absorption peak is an absorption peak specific to the phthalocyanine compound, and called “Q band”.

On the other hand, in the comparative example 4, these peaks were not observed. Thus, it was confirmed the phthalocyanine compound was aggregated in the aqueous solution and that a precipitate was formed in the comparative example 4.

As is clear from the description above, the phthalocyanine compound was dissolved in the aqueous solution in the example 4. On the other hand, the phthalocyanine compound was not dissolved in the aqueous solution in the comparative example 4.

### Example 5

In the example 5, the reagents shown in Table 4 were mixed to obtain an aqueous solution.

TABLE 4
50 mM MES—LiOH(pH: 7)
100 mM NaCl
10 mM CuCl₂
100 μM Copper(II) phthalocyanine-3,4′,4″,4″′-tetrasulfonic
acid tetrasodium salt
100 μM G-quadruplex1
Water
(Total volume: 100 μL)

The aqueous solution thus obtained was stored at 80 degrees Celsius for 2 minutes. Then, the aqueous solution was cooled to 20 degrees Celsius at a rate of 2 degrees Celsius/minute. Thereafter, the aqueous solution was left at room temperature for three hours.

### Comparative Example 5

In the comparative example 5, the experiment similar to the one in the example 5 was performed, except that the 100 μM G-quadruplex1 was not used.

Similarly in the case of the example 4, the absorbance of the aqueous solutions obtained in the example 5 and the comparative example 5 was measured.

FIG. 4 shows the measurement results of the absorbance in the example 5 and in the comparative example 5.

As shown in FIG. 4, in the example 5, the first absorbance peak (Soret Band) and the second absorbance peak (Q band) were observed in the wavelength of 300 nanometers-400 nanometers and in the wavelength of 600 nanometers-700 nanometers, respectively.

On the other hand, in the comparative example 5, these peaks were not observed. Accordingly, in the comparative example 5, it is confirmed that the phthalocyanine compound was aggregated in the aqueous solution and that a precipitate was formed.

As is clear from the description above, the phthalocyanine compound was dissolved in the aqueous solution in the example 5. On the other hand, the phthalocyanine compound was not dissolved in the aqueous solution in the comparative example 5.

### Example 6

In the example 6, G-quadruplex was mixed in an aqueous solution containing the divalent metal cations and the phthalocyanine compound modified with an anionic functional group.

In the example 6, the reagents shown in Table 5 were mixed to prepare an +Mg aqueous solution.

TABLE 5
+Mg aqueous solution

50 mM MES—LiOH (pH: 7)
100 mM KCl
10 mM MgCl₂
100 μM Copper(II) phthalocyanine-
3,4′,4″,4′″ -tetrasulfonic acid tetrasodium salt
Water
(Total volume: 50 microliters)

The reagents shown in Table 6 were mixed to prepare an —Mg aqueous solution. Unlike the +Mg aqueous solution, the —Mg aqueous solution did not contain magnesium ion.

TABLE 6
−Mg aqueous solution

50 mM MES—LiOH(pH: 7)
100 mM KCl
100 μM Copper(II) phthalocyanine-3,4′,4″,4″′-tetrasulfonic acid
tetrasodium salt
Water
(Total solution: 50 microliters)

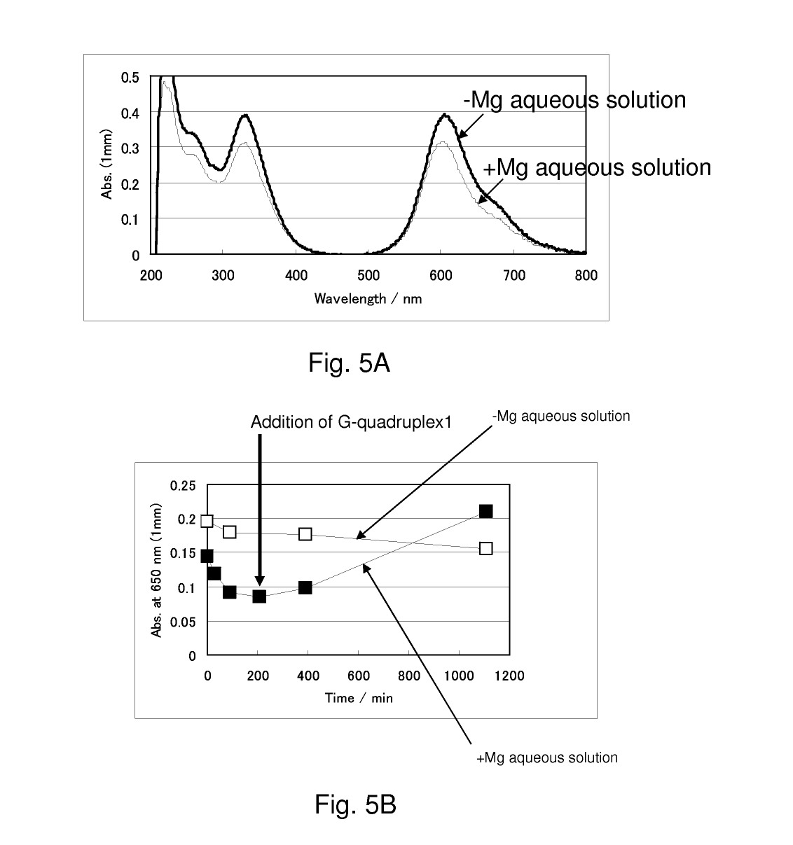

Immediately after the +Mg aqueous solution and —Mg aqueous solution were prepared, the absorbance of the +Mg aqueous solution and —Mg aqueous solution was measured. FIG. 5A shows the measurement results of the absorbance.

As shown in FIG. 5A, the absorbance of the +Mg aqueous solution is smaller than the absorbance of the —Mg aqueous solution. This means that the phthalocyanine compounds aggregated and formed a precipitate in the presence of magnesium ions immediately after the +Mg aqueous solution is prepared.

After this, the +Mg aqueous solution and —Mg aqueous solution were left at 25 degrees Celsius.

At the time point when 210 minutes elapsed from the completion of the preparation of the +Mg aqueous solution, five nano moles of dried G-quadruplex was added to the +Mg aqueous solution.

The absorbance of the +Mg aqueous solution and —Mg aqueous solution at a wavelength of 650 nanometers was measured.

Table 7 shows the measurement results of the absorbance at a wavelength of 650 nanometers. “Time (minutes)” at the left column of Table 7 represents the time elapsed since the preparation of the aqueous solution has been completed.

TABLE 7

| | Absorbance at wavelength of 650 nanometers | |
|---|---|---|
| Time(min) | −Mg aqueous solution | +Mg aqueous solution |
| 0 | 0.196 | 0.144 |
| 30 | — | 0.119 |
| 90 | 0.18 | 0.091 |
| 210 | — | 0.085 |
| 390 | 0.176 | 0.098 |
| 1110 | 0.155 | 0.21 |

FIG. 5B shows a graph formed on the basis of Table 7.

As is clear from FIG. 5B, the absorbance of the +Mg aqueous solution at a wavelength of 650 was decreased before G-quadruplex was added. This means that the phthalocyanine compound was precipitated.

Meanwhile, After G-quadruplex was added, the absorbance of the +Mg aqueous solution at a wavelength of 650 nanometers was increased. At the time point when 1110 minutes elapsed from the preparation of the +Mg aqueous solution, the +Mg aqueous solution had a higher absorbance than the —Mg aqueous solution. This means that the phthalocyanine compound was dissolved in the +Mg aqueous solution.

These results revealed that the phthalocyanine was dissolved in the +Mg aqueous solution when G-quadruplex was added to the aqueous solution containing the phthalocyanine compound and magnesium ions.

### Example 7A

In Example 7A, divalent metal cations were mixed to an aqueous solution containing G-quadruplex and a phthalocyanine compound modified with an anionic functional group.

In the example 7A, the reagents shown in Table 8 were mixed to prepare a +G aqueous solution. The prepared +G solution was stored at 80 degrees Celsius for 2 minutes. Then, the aqueous solution was cooled to 20 degrees Celsius at a rate of 2 degrees Celsius. Hereinafter, this procedure is referred to as “annealing”

TABLE 8
+G aqueous solution

50 mM MES—LiOH (pH: 7)
100 mM KCl
100 μM Copper(II) phthalocyanine-
3,4′,4″,4″′-tetrasulfonic acid tetrasodium salt
100 μM G-quadruplex1
Water
(Total volume: 50 microliters)

The reagents shown in Table 9 were mixed to prepare −G aqueous solution. Unlike the +G aqueous solution, the −G aqueous solution did not contain the G-quadruplex1.

TABLE 9
−G aqueous solution

50 mM MES—LiOH (pH: 7)
100 mM KCl
100 μM Copper(II) phthalocyanine-
3,4′,4″,4″′-tetrasulfonic acid tetrasodium salt
Water
(Total volume: 50 microliters)

The +G aqueous solution and the −G aqueous solution were left at 25 degrees Celsius for 45 minutes.

Then, MgCl₂ was added to the +G aqueous solution and the −G aqueous solution. After the addition, the concentration of magnesium ions was 100 mM.

The absorbance of +G aqueous solution and −G aqueous solution at a wavelength of 650 nanometers was measured at 25 degrees Celsius.

Table 10 shows the measurement results of the absorbance. “Time (minutes)” at the left column of Table 10 represents the time elapsed from the time point when MgCl₂ was added.

TABLE 10

| | Absorbance at wavelength of 650 nanometers | | |
|---|---|---|---|
| Time | −G aqueous | +G aqueous solution | +G aqueous solution |
| (minutes) | solution | (with the annealing) | (without the annealing) |
| 0 | 0.144 | 0.13 | 0.132 |
| 60 | 0.089 | 0.165 | 0.17 |
| 120 | 0.08 | 0.177 | 0.148 |
| 240 | 0.095 | 0.183 | 0.172 |

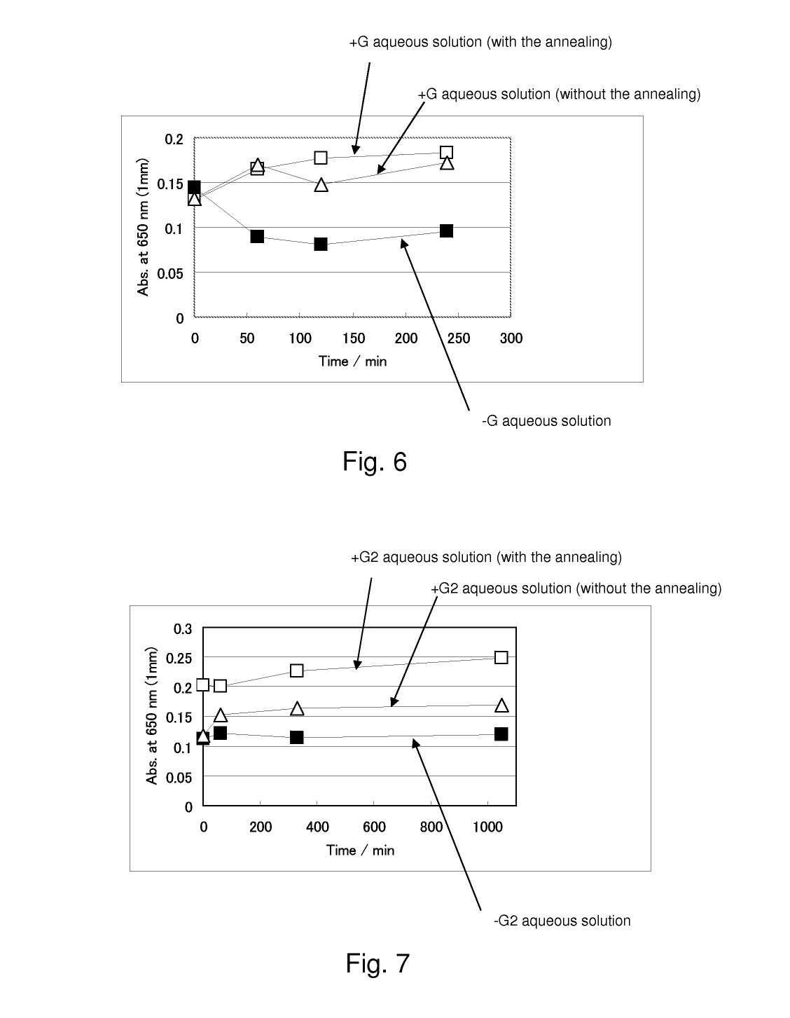

FIG. 6 shows a graph formed on the basis of Table 10.

As is clear from FIG. 6, the absorbance of the +G aqueous solution at a wavelength of 650 nanometers was increased after Mg²⁺ was added. This means that the phthalocyanine compound was dissolved in the +G aqueous solution.

Meanwhile, after Mg²⁺ was added, the absorbance of the −G aqueous solution at a wavelength of 650 nanometers was decreased. This means that the phthalocyanine compound was not dissolved in the −G aqueous solution but precipitated.

### Example 7B

In the example 7B, an experiment similar to that of the example 7A was conducted, except that the annealing was not performed. The result is shown in Table 10 and FIG. 6.

### Example 8A

In the example 8A, a phthalocyanine compound modified with an anionic functional group was mixed in an aqueous solution containing G-quadruplex and divalent metal cations.

In the example 8A, the reagent shown in Table 11 were mixed to prepare a +G2 aqueous solution. Similarly to the case of the example 7A, the prepared +G2 aqueous solution was subjected to the annealing.

TABLE 11
+G2 aqueous solution

50 mM MES—LiOH (pH: 7)
100 mM KCl
100 mM MgCl₂
100 mM G-quadruplex1
Water
(Total volume: 50 microliters)

The reagents shown in Table 12 were mixed to prepare a −G2 aqueous solution. Unlike the +G2 aqueous solution, the −G2 aqueous solution did not contain G-quadruplex1.

TABLE 12

−G2 aqueous solution
50 mM MES—LiOH (pH: 7)
100 mM KCl
100 mM MgCl₂
Water
(Total volume: 50 microliters)

The +G2 aqueous solution and the −G2 aqueous solution were left at 25 degrees Celsius for 180 minutes.

Then, 100 μM copper (II) phthalocyanine −3,4′,″, 4′″-tetrasulfonic acid tetrasodium salt was added to the +G2 aqueous solution and the −G2 aqueous solution.

The absorbance of the +G2 aqueous solution and the −G2 aqueous solution at a wavelength of 650 nanometers was measured at 25 degrees Celsius.

Table 13 shows the measurement results of the absorbance at a wavelength of 650 nanometers.

TABLE 13

| | Absorbance at a wavelength of 650 nanometers | | |
|---|---|---|---|
| Time | −G2 aqueous | +G2 aqueous solution | +G2 aqueous solution |
| (minute) | solution | (with the annealing) | (without the annealing) |
| 0 | 0.113 | 0.202 | 0.118 |
| 60 | 0.121 | 0.2 | 0.153 |
| 330 | 0.114 | 0.226 | 0.163 |
| 1050 | 0.119 | 0.249 | 0.169 |

FIG. 7 shows a graph formed on the basis of Table 13.

As understood from FIG. 7, after the phthalocyanine compound was added, the absorbance of the +G2 aqueous solution at a wavelength of 650 nanometers was higher than that of the −G2 aqueous solution. This means that the phthalocyanine compound was dissolved in the +G2 aqueous solution, whereas the phthalocyanine compound was not dissolved in the −G2 aqueous solution but precipitated.

### Example 8B

In the example 8B, an experiment similar to that of the example 8A was conducted, except that the annealing was not conducted.

The result was shown in FIG. 7 and Table 13.

### Industrial Applicability

The method according to the present invention may be used in the following technical field.

(1) CD-R

CD-R requires near-infrared absorbing dye sensitive to a laser diode. Since the phthalocyanine compounds are stable for light, heat, and temperature, the phthalocyanine compound may be used as near-infrared absorbing dye (see Japanese laid-open patent application publication No. Hei 5-1272A).

(2) Plasma Display Panel

It is required that near-infrared light generated by plasma discharge in a plasma display panel is shielded. The phthalocyanine compounds shields the near infrared light (see Japanese laid-open patent application publication No. 2001-106689A).

(3) Dye for Water-Based Ink

See Patent Literature 3.

1. A method for obtaining an aqueous solution where divalent metal cations, a phthalocyanine compound modified with an anionic functional group, and G-quadruplex are dissolved, the method comprising step of:
(a) mixing the divalent metal cations, the phthalocyanine compound modified with the anionic functional group, and the G-quadruplex into water so as to dissolve the phthalocyanine compound in the water.

2. The method according to claim 1, wherein
in the step (a), the divalent metal cations, the phthalocyanine compound modified with an anionic functional group, and the G-quadruplex are mixed at the same time.

3. The method according to claim 1, wherein
the anionic functional group is at least one selected from the group consisting of a carboxyl group, a metal salt of the carboxyl group, a sulfo group, and a metal salt of the sulfo group.

4. The method according to claim 1, wherein
the phthalocyanine compound contains copper, zinc, cobalt, or nickel as a coordination metal.

5. The method according to claim 1, wherein
the phthalocyanine compound contains no coordination metal.

6. The method according to claim 1, wherein
the divalent metal cation is at least one selected from the group consisting of magnesium ion, nickel ion, cobalt ion (II), copper ion, zinc ion, and iron ion (II).

7. The method according to claim 1, wherein
the G-quadruplex is formed of four DNAs each consisting of 5′−GGGTTAGGGTTAGGGTTAGGG-3′ (SEQ ID:01), 5′-TGGGGT-3′ (SEQ ID:02), or 5′−GGGTTTGGG-3′ (SEQ ID:03).

8. A method for obtaining an aqueous solution where divalent metal cations, a phthalocyanine compound modified with an anionic functional group, and G-quadruplex are dissolved, the method comprising step of:
(b) mixing the G-quadruplex into an aqueous solution containing the divalent metal cations and the phthalocyanine compound modified with the anionic functional group so as to dissolve the phthalocyanine compound in the aqueous solution.

9. The method according to claim 8, wherein
the anionic functional group is at least one selected from the group consisting of a carboxyl group, a metal salt of the carboxyl group, a sulfo group, and a metal salt of the sulfo group.

10. The method according to claim 8, wherein
the phthalocyanine compound contains copper, zinc, cobalt, or nickel as a coordination metal.

11. The method according to claim 8, wherein
the phthalocyanine compound contains no coordination metal.

12. The method according to claim 8, wherein
the divalent metal cation is at least one selected from the group consisting of magnesium ion, nickel ion, cobalt ion (II), copper ion, zinc ion, and iron ion (II).

13. The method according to claim 8, wherein
the G-quadruplex is formed of four DNAs each consisting of 5′−GGGTTAGGGTTAGGGTTAGGG-3′ (SEQ ID:01), 5′-TGGGGT-3′ (SEQ ID:02), or 5′−GGGTTTGGG-3′ (SEQ ID:03).

14. A method for obtaining an aqueous solution where divalent metal cations, a phthalocyanine compound modified with an anionic functional group, and G-quadruplex are dissolved, the method comprising step of:
(c) mixing the divalent metal cations into an aqueous solution containing the G-quadruplex and the phthalocyanine compound modified with the anionic functional group so as to dissolve the phthalocyanine compound in the aqueous solution.

15. The method according to claim 14, wherein
the anionic functional group is at least one selected from the group consisting of a carboxyl group, a metal salt of the carboxyl group, a sulfo group, and a metal salt of the sulfo group.

16. The method according to claim 14, wherein
the phthalocyanine compound contains copper, zinc, cobalt, or nickel as a coordination metal.

17. The method according to claim 14, wherein
the phthalocyanine compound contains no coordination metal.

18. The method according to claim 14, wherein
the divalent metal cation is at least one selected from the group consisting of magnesium ion, nickel ion, cobalt ion (II), copper ion, zinc ion, and iron ion (II).

19. The method according to claim 14, wherein
the G-quadruplex is formed of four DNAs each consisting of 5′−GGGTTAGGGTTAGGGTTAGGG-3′ (SEQ ID:01), 5′-TGGGGT-3′ (SEQ ID:02), or 5′−GGGTTTGGG-3′ (SEQ ID:03).

20. A method for obtaining an aqueous solution where divalent metal cations, a phthalocyanine compound modified with an anionic functional group, and G-quadruplex are dissolved, the method comprising step of:
(d) mixing the phthalocyanine compound modified with the anionic functional group into an aqueous solution containing the G-quadruplex and the divalent metal cations so as to dissolve the phthalocyanine compound in the aqueous solution.

21. The method according to claim 20, wherein
the anionic functional group is at least one selected from the group consisting of a carboxyl group, a metal salt of the carboxyl group, a sulfo group, and a metal salt of the sulfo group.

22. The method according to claim 20, wherein
the phthalocyanine compound contains copper, zinc, cobalt, or nickel as a coordination metal.

23. The method according to claim 20, wherein
the phthalocyanine compound contains no coordination metal.

24. The method according to claim 20, wherein
the divalent metal cation is at least one selected from the group consisting of magnesium ion, nickel ion, cobalt ion (II), copper ion, zinc ion, and iron ion (II).

25. The method according to claim 20, wherein
the G-quadruplex is formed of four DNAs each consisting of 5′−GGGTTAGGGTTAGGGTTAGGG-3′ (SEQ ID:01), 5′-TGGGGT-3′ (SEQ ID:02), or 5′−GGGTTTGGG-3′ (SEQ ID:03).
